(19) United States
(12) Patent Application Publication
(10) Pub. No.: US 2003/0048765 A1
(43) Pub. Date: Mar. 13, 2003

(54) Wireless data communication system and method using a wireless transmission frame structure for increasing communication efficiency

(75) Inventor: Kyung-hun Jang, Suwon-city (KR)

Correspondence Address: The Law Offices of Eugene M Lee, PLLC, LEE & STERBA, P.C., Suite 2000, 1101 Wilson Boulevard, Arlington, VA, 22209, US

(73) Assignee: Samsung Electronics Co., Ltd.

(21) Appl. No.: 10/218,031

(22) Filed: Aug. 14, 2002

(30) Foreign Application Priority Data
Aug. 14, 2001 (KR) 2001-49034

(51) Int. Cl. H04B 7/212; H04J 3/00

(52) U.S. Cl. 370/337; 370/442

(57) ABSTRACT

A wireless data communication system and method using a wireless transmission frame structure for increasing communication efficiency, wherein the wireless transmission frame includes a broadcast period, a downlink period, an uplink period, an acknowledgement period and a contention period to perform wireless data communication between a network access center and a plurality of stations, and wherein during the acknowledgement period, the plurality of stations send an acknowledgement signal to the network access center confirming safe receipt of data. Through the acknowledgement period, a network access center can send data and check whether the data is completely transmitted in the same frame, thereby effectively performing real-time data service. Further, an allocation of a plurality of unique subcarrier channels to each station minimizes the resending of data because receipt of data is confirmed when only one of the allocated unique subcarrier channels is completely transmitted from each station.

### BACKGROUND OF THE INVENTION

1. Field of the Invention

The present invention relates to a wireless data communication system. More particularly, the present invention relates to a wireless data communication system and method using a wireless transmission frame structure for increasing communication efficiency.

2. Description of the Related Art

FIG. 1 is a view of a conventional transmission frame structure, for use in a wireless data system, which includes a broadcast period, a downlink period, an uplink period and a contention period.

Referring to FIG. 1, a network access center distributes or allocates an uplink resource to each station that accesses the network access center.

Each station transmits data to the network access center using the allocated uplink resource. The network access center also transmits data to each station via the downlink period.

In general, a wireless data communication system is less reliable than a cable channel in transmitting data due to the characteristics of the wireless channel. Therefore, unlike in a cable channel, the wireless data communication system requires a resending mechanism to improve the reliability of data transmission in a data link layer. The resending mechanism is based on an acknowledgement signal (hereinafter, denoted as ACK) or ACK timeout.

FIG. 2 is a view illustrating a conventional method of generating an ACK to be transmitted from each station to a network access center. Referring to FIG. 2, the network access center uses a downlink period for transmitting data to a certain station. Then, the related station receives the data from the network access center via the downlink period, and sends the ACK, which acknowledges receipt of the data, to the network access center. At this time, in a case that the station has already been allocated with an uplink resource via a broadcast period, the station sends the ACK together with data to the network access center, illustrated in FIG. 2.

However, because data stream is asymmetrical in most cases, it is very probable that the station is not allocated with the uplink resource at the time when the ACK is sent to the network access center.

FIG. 3 is a view explaining a conventional process of sending the ACK to a network access center when a certain station is not allocated with an uplink resource. Referring to FIG. 3, when a station is not given the uplink resource in a frame N, it requests the network access center to allocate an uplink resource for a frame N+1 via a contention period of the frame N, i.e., the station performs a bandwidth request. Once the uplink resource or bandwidth is allocated, the station sends the ACK to the network access center in an uplink period of the frame N+1. The station fails to receive data from the network access center completely when the bandwidth request or ACK is lost in a wireless interface or the data, which is transmitted from the network access center, is lost in transit. In this case, the network access center resends the data to the station.

FIG. 4 is a view explaining a conventional process of resending data when data is lost in a wireless interface. Referring to FIG. 4, in a case that data transmitted from a network access center is lost in a frame N, a station fails to completely receive the data, and thus cannot send the ACK to the network access center. If the network access center is not given the ACK within a limited time, i.e., the ACK timeout, from the station, the network access center concludes that the station failed to receive the data normally, and resends the data in a subsequent frame N+m.

Here, the ACK timeout is a relatively long time, and therefore, it will take that amount of time for the network access center to recognize a failure of the transmission of data and resend the data to the station. That is, the immediate resending of data is difficult to accomplish. For this reason, some conventional methods suggest omitting a resending mechanism for real-time data service, or to set the ACK timeout to be short, however, these procedures are insufficient to solve the above problem entirely.

### SUMMARY OF THE INVENTION

In an effort to solve the above-described problem, it is a first feature of an embodiment of the present invention to provide a wireless data communication system that transmits data using a wireless transmission frame structure capable of minimizing the time spent for a network access center, within the wireless data communication system, to check if a station has received the data.

It is a second feature of an embodiment of the present invention to provide a wireless data communication system that allows a network access center to send data to a station and check whether the data is completely sent to a station in the same frame, and a method therefor.

It is a third feature of an embodiment of the present invention to provide a recording medium that records such a wireless data communication method as a program code that can be executed by a computer.

Accordingly, to provide the first feature, there is provided a wireless data communication system that performs a wireless data communication between a network access center and a plurality of stations. The wireless data communication system performs a wireless data communication using a wireless transmission frame structure including a broadcast period, a downlink period, an uplink period, an acknowledgement period and a contention period. The acknowledgement period is a period in which a plurality of stations send an acknowledgement signal confirming to the network access center safe receipt of data transmitted from the network access center.

To provide the second feature, there is provided a wireless data communication system performing a wireless data communication using a wireless transmission frame structure including a broadcast period, a downlink period, an uplink period, an acknowledgement period and a contention period, the wireless data communication system including a network access center for allocating a unique subcarrier channel to each one of a plurality of stations that requests access to the network access center and for sending data to each one of the plurality of stations that requests access to the network access center in the downlink period; and the plurality of stations being allocated with the unique subcarrier channel by the network access center when one or more of the plurality of stations accesses the network access center, the one or more of the plurality of stations activating the allocated unique subcarrier channel after receipt of data from the network access center in the downlink period and sending the activated unique subcarrier channel to the network access center in the acknowledgement period, wherein the network access center sends new data or resends the data, which was sent in the previous frame, in the next frame depending on whether the allocated unique subcarrier channel is activated.

To provide the third feature, there is provided a wireless data communication method carried out between a network access center and a plurality of stations using a wireless transmission frame structure including a broadcast period, a downlink period, an uplink period, an acknowledgement period and a contention period, the wireless data communication method including (a) the network access center allocating at least one unique subcarrier channel, which is to be used in the acknowledgement period, to each one of the plurality of stations that requests access to the network access center, and sending data to each one of the plurality of stations that requests access to the network access center in the downlink period; (b) each one of the plurality of stations that accesses the network access center activating the at least one unique subcarrier channel, which was allocated by the network access center, in the acknowledgement period when data is completely transmitted to the corresponding one of the plurality of stations from the network access center; and (c) the network access center checking the activation of the at least one unique subcarrier channel allocated to each one of the plurality of stations in the acknowledgement period and determining whether to send new data or resend the data which was previously sent according to the result of the check.

### BRIEF DESCRIPTION OF THE DRAWINGS

The above and other features and advantages of the present invention will become more apparent upon review of a detailed description of preferred embodiments thereof with reference to the attached drawings in which:

FIG. 1 illustrates a view of a conventional transmission frame structure adopted by a wireless data system;

FIG. 2 illustrates a view for explaining a conventional method of generating an acknowledgement signal (ACK) that is to be transmitted from each station to a network access center;

FIG. 3 illustrates a view for explaining a conventional process of transmitting an ACK to a network access center from a station that is not allocated with an uplink resource;

FIG. 4 illustrates a view for explaining a conventional process of resending data when the data is lost in a wireless interface;

FIG. 5 illustrates a view of a wireless transmission frame structure according to an embodiment of the present invention;

FIG. 6 is a schematic block diagram of a wireless data communication system that performs a data communication using the wireless transmission frame structure of FIG. 5;

FIG. 7 is a flow chart for explaining a wireless data communication method that is performed by the wireless data communication system of FIG. 6; and

FIG. 8 illustrates a view for explaining a process of sending data to each station according to the wireless data communication method of FIG. 7.

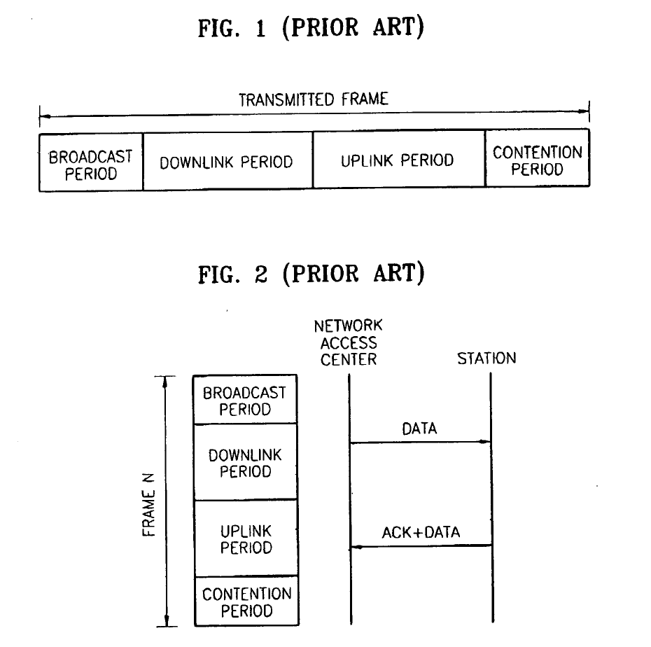

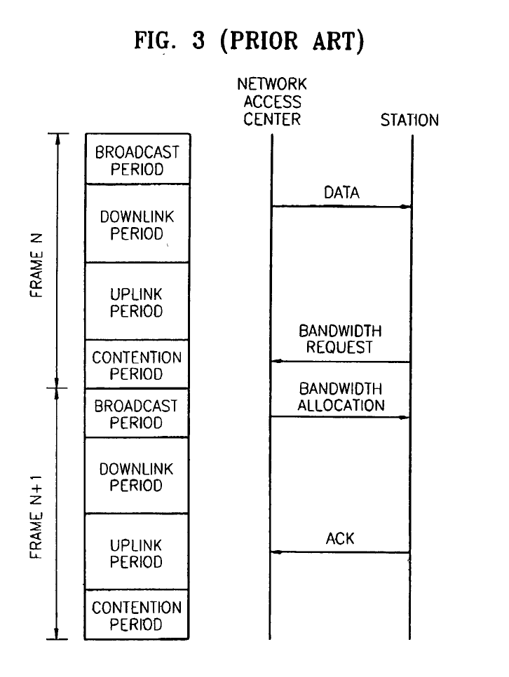

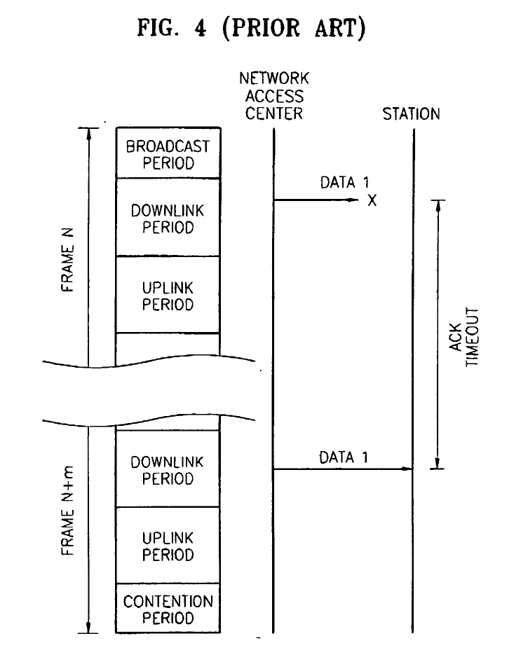

### DETAILED DESCRIPTION OF THE INVENTION

Korean Patent Application No. 2001-49034, filed on Aug. 14, 2001, and entitled: “Wireless Data Communication System and Method Using Wireless Transmission Frame Structure for Increasing Communication Efficiency,” is incorporated by reference herein in its entirety.

A wireless transmission frame structure that increases communication efficiency, a wireless data communication system that performs communication using the wireless transmission frame structure, and a method therefor will now be explained with reference to the accompanying drawings.

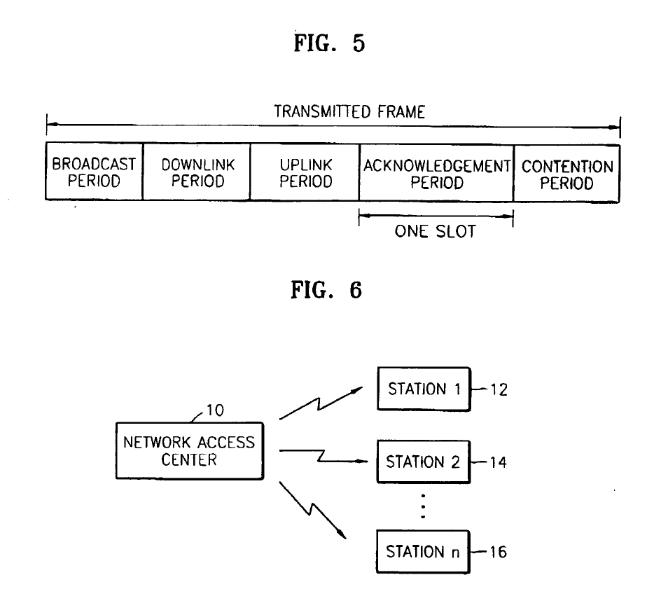

FIG. 5 illustrates a view of a wireless transmission frame structure according to an embodiment of the present invention. Referring to FIG. 5, this wireless transmission frame structure includes a broadcast period, a downlink period, an uplink period, an acknowledgement period, and a contention period.

The acknowledgement period is present between the uplink period and the contention period of the wireless transmission frame, and takes place when a station sends an acknowledgement signal (ACK) informing a network access center of the receipt of data. Through the acknowledgement period, the network access center may also check if the station normally receives the data in the frame at which the data is transmitted to the station. Preferably, the acknowledgement period is at least one slot time period.

FIG. 6 is a schematic block diagram of a wireless data communication system that performs a data communication using the wireless transmission frame. This wireless data communication system includes a network access center 10 and a plurality of stations 12, 14 and 16.

Referring to FIGS. 5 and 6, the network access center 10 allocates a unique subcarrier channel, which is to be used as the ACK in the acknowledgement period, to a certain station that requests access to the network access center. Preferably, at this time, the network access center 10 allocates the unique subcarrier channel to a station that requests real-time data service. In general, an orthogonal frequency division multiplex (OFDM) mode has a plurality of subcarrier channels in a carrier wave. For instance, a wireless local area network (WLAN) includes fifty-two (52) subcarrier channels, and a broadband wireless access (BWA) includes 512 or 1024 subcarrier channels. The network access center 10 allocates a plurality of unique subcarrier channels to each station and uses the allocated subcarrier channels as an ACK. In other words, the network access center 10 allocates unique subcarrier channels to a station that requests access to the network access center, and then sends data to the network-connected stations 12, 14 and 16 in a downlink period via a wireless communication network. Next, the network access center 10 checks the activation of the subcarrier channel allocated to each station in the acknowledgement period, and sends new data or resends the data, which was sent in the previous frame, to each station in the next frame.

Each of a plurality of stations 12, 14 and 16 is allocated with the unique subcarrier channel by the network access center 10 when it is connected to the network access center 10. If each of a plurality of stations 12, 14 and 16 normally receives data from the network access center 10 in the downlink period, it activates the allocated subcarrier channel in the acknowledgement period and sends the activated subcarrier to the network access center 10. However, in the event that a station does not normally receive the data, that station does not activate the allocated subcarrier channel so that it receives the data again in the next frame.

While the activated subcarrier channel is transmitted from each station to the network access center in the acknowledgement period, the activated subcarrier channel may be lost in the wireless communication network due to multi-path fading. Accordingly, the network access center 10 allocates a plurality of unique subcarrier channels to each station. The allocation of a plurality of subcarrier channels increases the probability that each station receives a subcarrier channel, which is used as the ACK. That is, when three subcarrier channels, for example, are allocated to each station, the network access center 10 considers each station as receiving data, even if only one of the three subcarrier channels is activated.

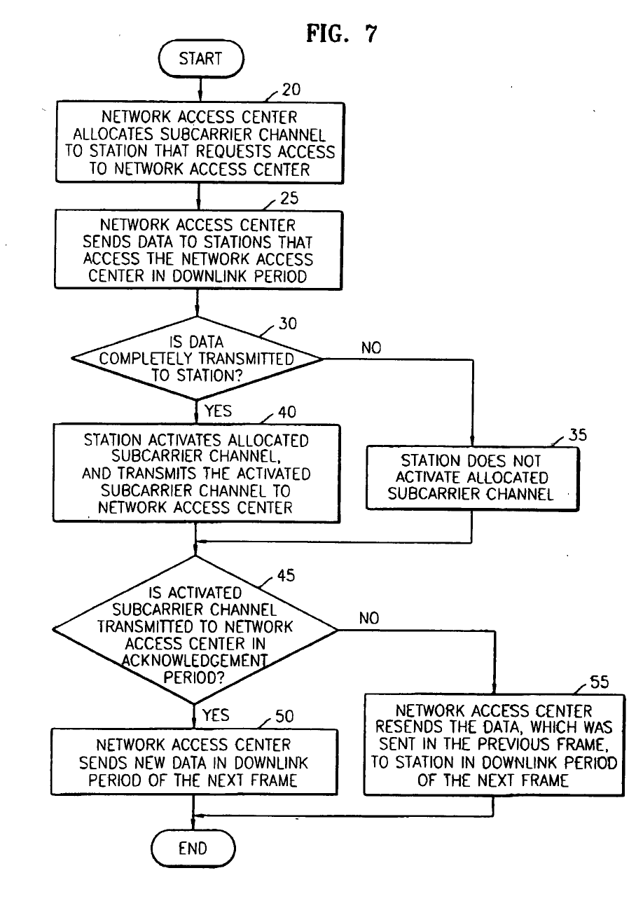

FIG. 7 is a flow chart explaining a preferred embodiment of a wireless data communication method performed by the wireless data communication system of FIG. 6.

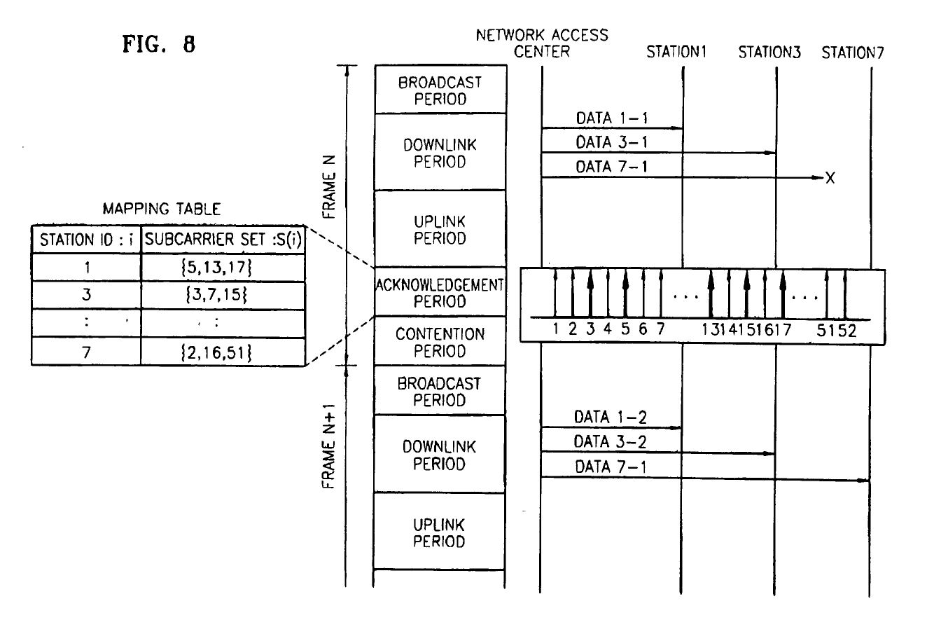

FIG. 8 illustrates a view explaining a process of transmitting data to each station according to the wireless data communication method of FIG. 7. Here, to facilitate the illustration, it is assumed that communication is performed in the WLAN, the number of stations that can access a network access center is seven, and the first, third and seventh stations presently access a network access center. Under these assumptions, as shown in the mapping table shown in FIG. 8, the first station is allocated with the fifth, thirteenth and seventeenth subcarrier channels, the third station is allocated with the third, seventh and fifteenth subcarrier channels, and the seventh station is allocated with the second, sixteenth and fifty-first subcarrier channels, for example.

A wireless data communication method will now be described in detail with reference to FIGS. 7 and 8. In step 20, the network access center allocates a unique subcarrier channel, which is the ACK to be used in an acknowledgement period, to a station that requests access to the network access center. Here, the network access center may allocate a plurality of unique subcarrier channels to each station to compensate for a possible loss of one or more of the subcarrier channels in the acknowledgement period. In this embodiment, as illustrated in FIG. 8, the number of subcarrier channels to be allocated to each station is set to an exemplary three.

In step 25, the network access center sends data to the stations that access the network access center in a downlink period of a frame, in this example, the first, third and seventh stations. That is, the network access center sends data DATA1-1, DATA3-1 and DATA 7-1 to the first, third and seventh stations in the downlink period of a frame N, respectively, and each station selectively receives the corresponding one of the data DATA1-1, DATA3-1 and DATA7-1.

In step 30, each station connected to the network access center checks if the related data is completely received. If the transmission of the data is satisfactorily completed, in step 40, each station activates the subcarrier channels received in step 20 and sends the activated subcarrier channels to the network access center in the acknowledgement period of the frame N. However, in the event that the transmission of data is incomplete, in step 35, a station does not activate the subcarrier channels received in step 20. Referring to FIG. 8, the first and third stations receive the data DATA1-1 and the data DATA3-1 from the network access center, respectively. However, the data DATA7-1 is lost in transit and therefore, the data DATA7-1 is not received by the seventh station. Accordingly, the first and third stations activate the allocated fifth, thirteenth and seventeenth subcarrier channels, and third, seventh and fifteenth subcarrier channels, respectively, and send them to the network access center via the acknowledgement period of the frame N. However, since the seventh station does not receive the data, it does not activate the second, sixteenth and fifty-first subcarrier channels allocated in step 20.

In step 45, the network access center checks whether the subcarrier channels are activated in the acknowledgement period of the frame N, and sends next data, in step 50, to stations in which the given subcarrier channels are activated, i.e., the first and third stations, during a downlink period of a frame N+1. However, in step 55, the network access center resends the data, which was sent during the downlink period of the frame N, in the downlink period of the frame N+1 to a station having inactivated subcarrier channels, i.e., the seventh station. More specifically, referring to FIG. 8, the network access center checks receipt of the activated subcarrier channels in the acknowledgement period of the frame N, and as a result, recognizes the activation of the third, fifth, thirteenth, fifteenth and seventeenth subcarrier channels. Here, the fifth, thirteenth and seventeenth subcarrier channels are the subcarrier channels allocated to the first station, and the third and fifteenth subcarrier channels are two of the three subcarrier channels allocated to the third station. That is, all of the subcarrier channels allocated to the first station are activated and only two of the three subcarrier channels allocated to the third station, are activated. The seventh subcarrier channel, allocated to the third station, was lost in transit. Moreover, none of the subcarrier channels allocated to the seventh station are activated. Thus, the network access center determines that the first and third stations, in which at least one of the subcarrier channels are activated, received the data, and that the seventh station, in which none of the subcarrier channels are activated, failed to completely receive the data.

Subsequently, in the downlink period of the next frame, i.e., the frame N+1, the network access center sends new data DATA1-2 and DATA3-2 to the first and third stations, respectively, and resends the data DATA7-1 that was sent in the frame N to the seventh station.

As described above, a network access center can send data to each station and check whether the data is completely transmitted to each station in the same frame, thereby effectively performing real-time data service. Additionally, the allocation of a plurality of unique subcarrier channels to each station minimizes the resending of data because receipt of data is confirmed when at least one of the allocated subcarrier channels is completely transmitted from each station, even if a greater number of the subcarrier channels are lost in a wireless interface.

Further, the present invention may be embodied as a computer readable code in a computer readable medium. Here, the computer readable medium may be any recording apparatus capable of storing data that can be read by a computer system, e.g., a read-only memory (ROM), a random access memory (RAM), a compact disc (CD)-ROM, a magnetic tape, a floppy disk, an optical data storage device, and the like. Also, the computer readable medium may be a carrier wave that transmits data via the Internet, for example. The computer readable recording medium can be installed in a computer connected to a network, stored and used as a computer readable code by a distributed computing environment.

Preferred embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A wireless data communication system comprising:
a network access center; and
a plurality of stations, the wireless data communication system performing wireless data communication between the network access center and the plurality of stations,
wherein the wireless data communication system performs a wireless data communication using a wireless transmission frame structure including a broadcast period, a downlink period, an uplink period, an acknowledgement period and a contention period, and
wherein the acknowledgement period is a period in which the plurality of stations send an acknowledgement signal to the network access center confirming safe receipt of data transmitted from the network access center.

2. The wireless data communication system as claimed in claim 1, wherein the acknowledgement period is at least one slot time period.

3. The wireless data communication system as claimed in claim 1, wherein the acknowledgement signal comprises at least one subcarrier channel, and
the network access center provides the subcarrier channel to each station that requests access to the network access center.

4. A wireless data communication system performing a wireless data communication using a wireless transmission frame structure including a broadcast period, a downlink period, an uplink period, an acknowledgement period and a contention period, the wireless data communication system comprising:
a network access center for allocating a unique subcarrier channel to each one of a plurality of stations that requests access to the network access center and for sending data to each of the plurality of stations that requests access to the network access center in the downlink period; and
the plurality of stations being allocated with the unique subcarrier channel by the network access center when one or more of the plurality of stations accesses the network access center, the one or more of the plurality of stations activating the allocated unique subcarrier channel after receipt of data from the network access center in the downlink period and sending the activated unique subcarrier channel to the network access center in the acknowledgement period,
wherein the network access center sends new data or resends the data, which was sent in the previous frame, in the next frame depending on whether the allocated unique subcarrier channel is activated.

5. The wireless data communication system as claimed in claim 4, wherein the network access center allocates the unique subcarrier channel to each one of the plurality of stations that requests real-time data service.

6. The wireless data communication system as claimed in claim 4, wherein the network access center allocates at least two unique subcarrier channels to each one of the plurality of stations that requests access to the network access center.

7. A wireless data communication method carried out between a network access center and a plurality of stations using a wireless transmission frame structure including a broadcast period, a downlink period, an uplink period, an acknowledgement period and a contention period, the wireless data communication method comprising:
(a) the network access center allocating at least one unique subcarrier channel, which is to be used in the acknowledgement period, to each one of the plurality of stations that requests access to the network access center, and sending data to each one of the plurality of stations that requests access to the network access center in the downlink period;
(b) each one of the plurality of stations that accesses the, network access center activating the at least one unique subcarrier channels, which was allocated by the network access center, in the acknowledgement period when data is completely transmitted to the corresponding one of the plurality of stations from the network access center; and
(c) the network access center checking the activation of the at least one unique subcarrier channel allocated to each one of the plurality of stations in the acknowledgement period and determining whether to send new data or resend the data which was previously sent according to the result of the check.

8. The wireless data communication method as claimed in claim 7, wherein during (a), the network access center allocates the at least one unique subcarrier channel to each one of the plurality of stations that requests real-time data service.

9. The wireless data communication method as claimed in claim 7, wherein in a downlink period of a next frame, the network access center sends new data to each one of the plurality of stations that activates at least one of the allocated unique subcarrier channels in the acknowledgement period, and resends the data, which was sent in the downlink period in (a), to each one of the plurality of stations that does not activate at least one of the allocated unique subcarrier channels.

10. A recording medium having recorded thereon a computer executable program code for the wireless data communication method as claimed in claim 7.
